(19) United States
(12) Patent Application Publication
(10) Pub. No.: US 2021/0240339 A1
(43) Pub. Date: Aug. 5, 2021

(54) UNIFIED HOVER IMPLEMENTATION FOR TOUCH SCREEN INTERFACES

(71) Applicant: salesforce.com, inc., San Francisco, CA (US)

(72) Inventor: Naga Siva Chandra Prasad PAMIDI, Dublin, CA (US)

(73) Assignee: salesforce.com, inc., San Francisco, CA (US)

(21) Appl. No.: 16/778,685

(22) Filed: Jan. 31, 2020

(51) Int. Cl. G06F 3/0488; G06F 3/0481; G06F 3/01; G06F 9/451

(52) U.S. Cl. CPC G06F 3/04883; G06F 9/453; G06F 3/016; G06F 3/04812

(57) ABSTRACT

Disclosed herein are system, method, and computer program product embodiments for performing hover operations, where a cursor is rested over a visual element, on devices that do not have cursors (such as touchscreens). The approaches provided herein allows application developers to implement hover functionality uniformly across desktop systems supporting cursors, and mobile systems that do not support cursor functionality.

### BACKGROUND

When interacting with a visualization, such as a graph, tooltips are helpful in quickly providing additional details regarding some portion of the visualization without navigating to a different area of the application. However, these approaches have been principally developed with desktop environments in mind, and suffer various drawbacks when applied to other environments.

Accordingly, what is needed is a way to interact with tooltips in non-desktop environments.

### BRIEF DESCRIPTION OF THE DRAWINGS

The accompanying drawings are incorporated herein and form a part of the specification.

FIG. 1 illustrates an exemplary implementation of a tooltip on a visualization, in accordance with an embodiment.

FIG. 2 is a flowchart illustrating steps by which a hover interaction can be handled on a touchscreen interface, in accordance with an embodiment.

FIG. 3 illustrates an architecture for handling hover interactions in touch interfaces, in accordance with an embodiment.

FIGS. 4A and 4B illustrate an exemplary operation of the long press operation, in accordance with an embodiment.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing tooltips on touchscreen interfaces in an intuitive manner.

When interacting with visualizations on a desktop system, tooltips have been a preferred mechanism for designers to convey information about a visual element. The information conveyed by tooltips varies depending on the application, and may include a drill-down of data represented by the visual element, help information about the visual element, or other related additional information.

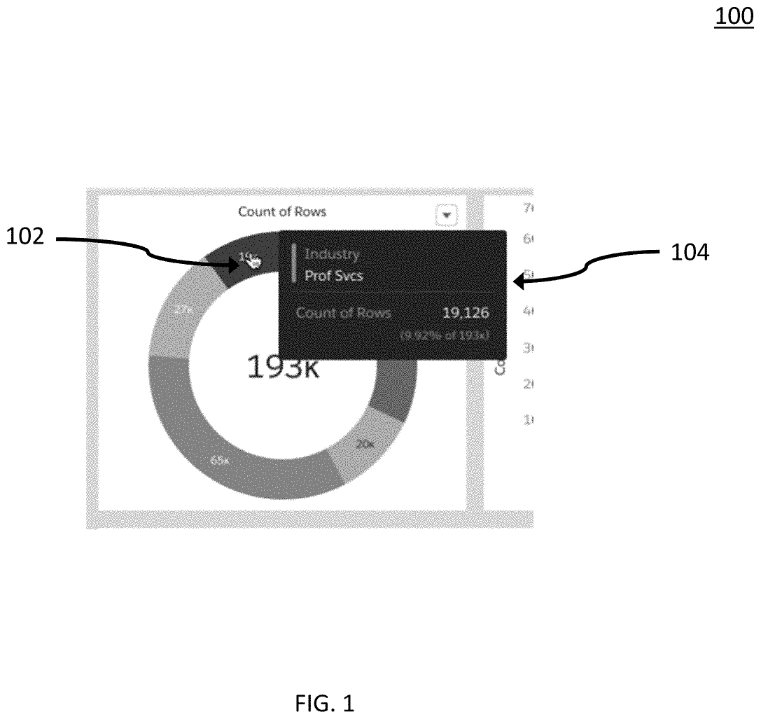

FIG. 1 illustrates an exemplary implementation of a tooltip on a visualization 100, in accordance with an embodiment. In visualization 100, a graph illustrating a “count of rows” is shown, and when a cursor 102 hovers over one of the individual elements of the visualization, a corresponding tooltip 104 is presented, in accordance with an embodiment.

In this example, tooltip 104 shows additional information about the one of the individual elements, including information that was not already shown in visualization 100. A user may move the cursor 102 to other elements of the visualization in order to see a similar tooltip corresponding to each of the other elements.

On a typical desktop interface, a user interacts with applications using cursor-based inputs, such as a mouse, a trackball, or trackpad, for example. Applications can therefore respond to the position of the cursor to perform certain operations, whether or not the user has performed any actions (e.g., clicking a mouse button) apart from moving the cursor.

Applications developed for the desktop that respond in this manner would implement a “hover” function. By way of non-limiting example, a desktop operating system would automatically recognize such a hover function, and the application developer would provide implementation details for the behavior associated with the hover function. Based on a location of the cursor when the hover function is called (e.g., after the cursor stops moving for some predetermined time at a particular location on a display), the hover behavior for an element under the cursor is executed.

Unlike desktops, other types of computing devices have interfaces that are not based around cursors. For example, tablets and smartphones (and other types of mobile devices) commonly rely on touch and gesture-based controls on a touchscreen, and do not track a cursor position. However, as tooltips remain valuable visual elements for conveying information even on these platforms, tooltips are available to mobile device developers for use in mobile applications even though cursors are not available.

Without a cursor present, application developers must call up tooltips using something other than a hover function (which relies on the location of a cursor after some period of time without movement). Typically, on mobile devices, this is handled by tapping on a visual element in order to interact with it, resulting in the tooltip appearing.

However, tapping on a visual element to select it on a mobile device screen typically performs additional actions beyond simply summoning the tooltip. For example, selecting the visual element may perform additional computationally expensive operations (e.g., database queries) that would not be necessary solely to display a tooltip. As a result, the usability of tooltips on mobile devices is limited by comparison to desktop applications.

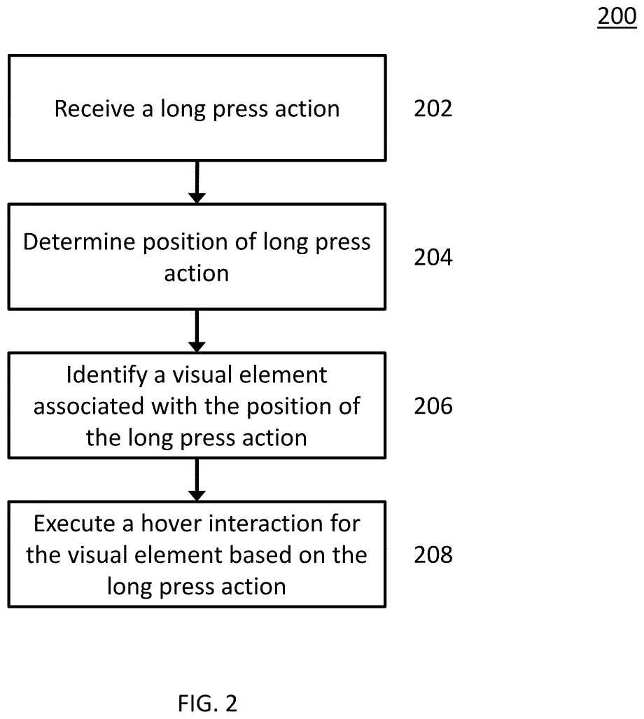

FIG. 2 is a flowchart 200 illustrating steps by which a hover interaction can be handled on a touchscreen interface, in accordance with an embodiment. At step 202, a long press action by a user is received and identified. In accordance with an embodiment, a long press action occurs when a user touches the screen, and maintains contact with the screen for at least a defined period of time.

A long press action is distinguished from a selection in that a selection is a tap (a quick tap—the contact is less than the defined period of time for the long press), and takes effect upon release of contact.

When a long press action is received, the position of the long press action is determined at step 204, in accordance with an embodiment. Based on this position, a visual element associated with this position on a display is determined at step 206.

At step 208, a hover interaction is executed on the visual element associated with the position on the display, on the basis of this long press action.

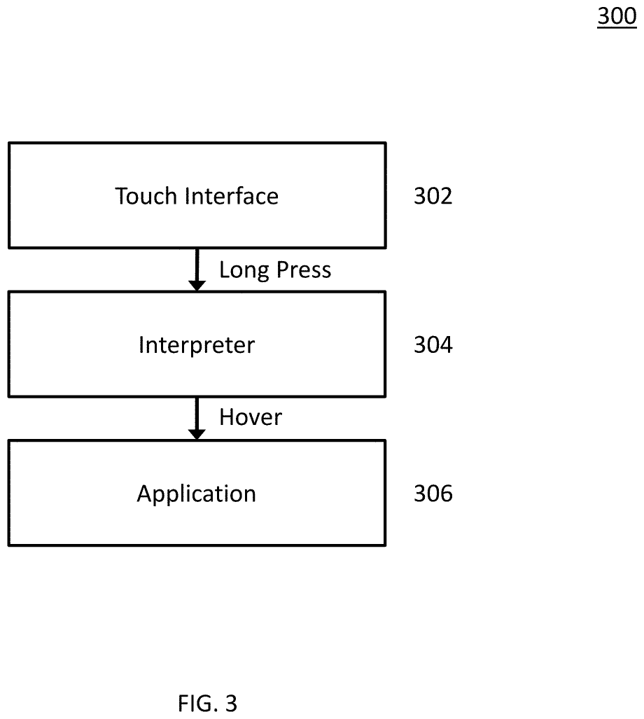

FIG. 3 illustrates an architecture 300 for handling hover interactions in touch interfaces, in accordance with an embodiment. Touch interface 302 is configured to detect various touch interactions with the display, including various gestures such as a long press. In accordance with an embodiment, touch interface 302 is implemented by an operating system of a mobile device associated with the display.

In architecture 300, a detected long press is passed to interpreter 304, in accordance with an embodiment. Interpreter 304 may be configured to perform the operations of flowchart 200 of FIG. 2, and serves as an intermediate layer between the operating system and an application 306 (which would be a mobile application in a mobile device environment). In accordance with an embodiment, interpreter 304 is configured to obtain information about the long press interaction, such as a position on the display associated with the interaction, and form a hover interaction call to application 306.

By implementing interpreter 304 in this manner, application 306 need not be modified between desktop and mobile implementations with respect to hover operations—a developer of application 306 may implement hover functionality to operate in a platform-independent manner.

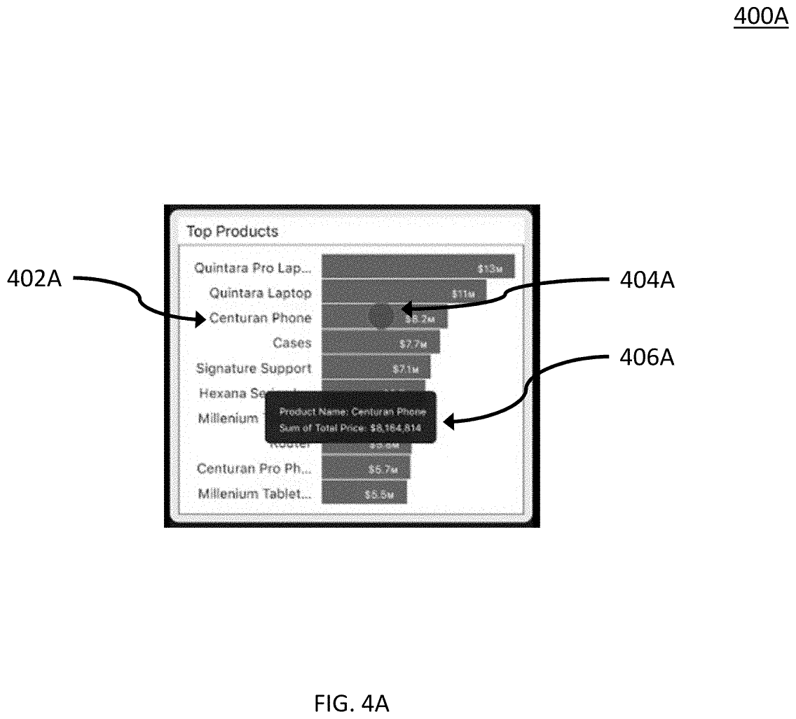

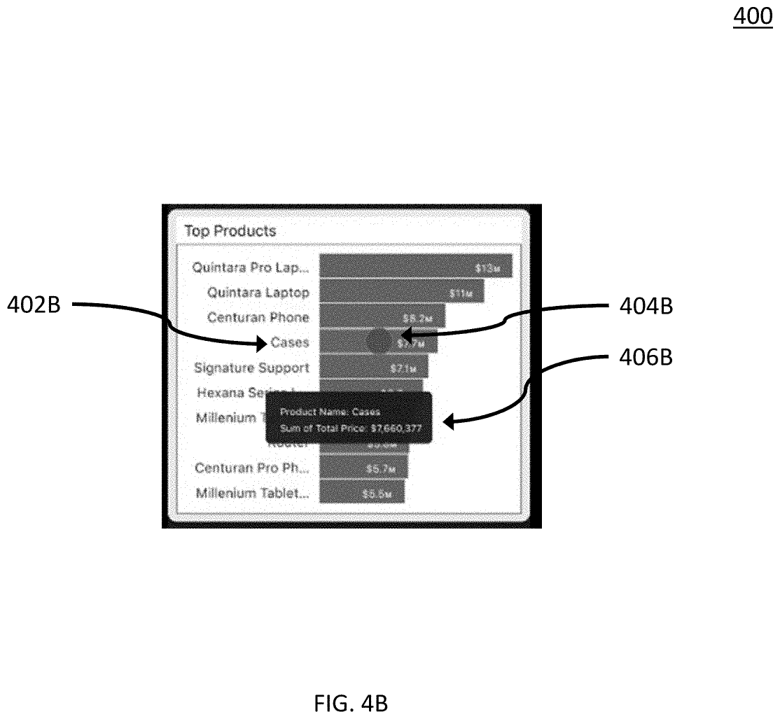

FIGS. 4A and 4B illustrate an exemplary operation of the long press operation, in accordance with an embodiment. 400A of FIG. 4A is an exemplary display of a mobile application comprising various visual elements, including a bar chart including element 402A. 404A illustrates a location of a touch interaction with the display. In this example, the touch interaction is a long press located over element 402A, resulting in tooltip 406A being displayed with information relating to element 402A.

While continuing to hold down the press, a user can move their touch (e.g., a finger or stylus) to a different element and display the appropriate tooltip. In FIG. 4B, exemplary display 400B shows that the location of touch interaction 404B is now over element 402B, and tooltip 406B reflects the information associated with element 402B. This process may repeat for any number of visual elements as the long press action is moved to over other visual elements.

By way of non-limiting embodiment, the tooltips can be displayed on an area of the display where it would be visible to a user despite the long press interaction interfering with visibility. For example, rather than showing the tooltip directly under a user's finger, the tooltip may be shown at an area of the display distant from a location of touch interaction such as 404A or 404B. This location may also move, in accordance with an embodiment, as the location of the touch interaction changes.

In an embodiment, haptic feedback may be provided to a user at various steps of the interactions described above. Support for haptic feedback may depend on the availability of haptic feedback hardware on a host mobile device, as would be understood by a person skilled in the relevant art. For example, haptic feedback may be provided when the long press interaction occurs (e.g., once the touch interaction has been made, and sustained past the defined period of time for associating a touch as a long press). Additionally, when moving the touch interaction around the display while sustaining the long press, haptic feedback may be provided as the interaction moves over a new visual element.

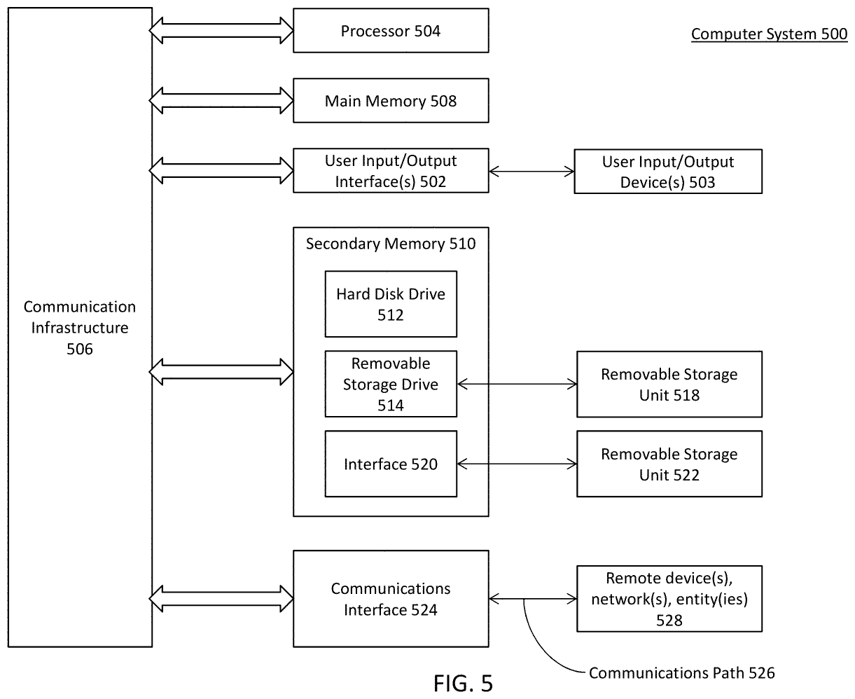

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include customer input/output device(s) 503, such as monitors, keyboards, pointing devices, etc., which may communicate with communication infrastructure 506 through customer input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A method, comprising:
receiving, at an interpreter executing on one or more computing devices, an input corresponding to a long press action on a touch screen from an operating system;
determining, by the interpreter, a position of the long press action within a graphical user interface (GUI) of an application displayed on the touch screen;
identifying, by the interpreter responsive to receiving the input, a first visual element of the GUI that is located at the position of the long press action; and
calling, by the interpreter, a cursor hover interaction function of the first visual element of the GUI responsive to the identifying.

2. The method of claim 1, wherein the cursor hover interaction function is implemented within the application and is configured to display an additional visual element related to the first visual element within the GUI.

3. The method of claim 2, wherein the additional visual element is displayed at a location separated from the position of the long press action.

4. The method of claim 1, wherein the cursor hover interaction function is responsive to a cursor hover interaction performed on a desktop implementation of the application.

5. The method of claim 1, further comprising:
determining, by the interpreter, a new position of the long press action within the GUI; and
calling, by the interpreter, the cursor hover interaction function of the application for a second visual element of the GUI located at the new position of the long press action.

6. The method of claim 1, further comprising:
providing, by the one or more computing devices, haptic feedback responsive to the identifying the first visual element.

7. The method of claim 1, wherein the input is received from an operating system upon which the application is executing.

8. A system, comprising:
a memory configured to store operations; and
one or more processors configured to perform the operations, the operations comprising:
receiving, at an interpreter, an input corresponding to a long press action on a touch screen from an operating system,
determining, by the interpreter, a position of the long press action within a graphical user interface (GUI) of an application displayed on the touch screen,
identifying, by the interpreter responsive to receiving the input, a first visual element of the GUI that is located at the position of the long press action, and
calling, by the interpreter, a cursor hover interaction function of the first visual element of the GUI responsive to the identifying.

9. The system of claim 8, wherein the cursor hover interaction function is implemented within the application and is configured to display an additional visual element related to the first visual element within the GUI.

10. The system of claim 9, wherein the additional visual element is displayed at a location separated from the position of the long press action.

11. The system of claim 8, wherein the cursor hover interaction function is responsive to a cursor hover interaction performed on a desktop implementation of the application.

12. The system of claim 8, the operations further comprising:
determining, by the interpreter, a new position of the long press action within the GUI; and
calling, by the interpreter, the cursor hover interaction function of the application for a second visual element of the GUI located at the new position of the long press action.

13. The system of claim 8, the operations further comprising:
providing haptic feedback responsive to the identifying the first visual element.

14. The system of claim 8, wherein the input is received from an operating system upon which the application is executing.

15. A non-transitory computer readable storage device having instructions stored thereon, execution of which, by one or more processing devices, causes the one or more processing devices to perform operations comprising:
receiving, at an interpreter, an input corresponding to a long press action on a touch screen from an operating system;
determining, by the interpreter, a position of the long press action within a graphical user interface (GUI) of an application displayed on the touch screen;
identifying, by the interpreter responsive to receiving the input, a first visual element of the GUI that is located at the position of the long press action; and
calling, by the interpreter, a cursor hover interaction function of the first visual element of the GUI responsive to the identifying.

16. The non-transitory computer readable storage device of claim 15, wherein the cursor hover interaction function is implemented within the application and is configured to display an additional visual element related to the first visual element within the GUI.

17. The non-transitory computer readable storage device of claim 16, wherein the additional visual element is displayed at a location separated from the position of the long press action.

18. The non-transitory computer readable storage device of claim 15, wherein the cursor hover interaction function is responsive to a cursor hover interaction performed on a desktop implementation of the application.

19. The non-transitory computer readable storage device of claim 15, the operations further comprising:
determining, by the interpreter, a new position of the long press action within the GUI; and
calling, by the interpreter, the cursor hover interaction function of the application for a second visual element of the GUI located at the new position of the long press action.

20. The non-transitory computer readable storage device of claim 15, further comprising:
providing haptic feedback responsive to the identifying the first visual element.
